(19) United States
(12) Patent Application Publication
(10) Pub. No.: US 2006/0290259 A1
(43) Pub. Date: Dec. 28, 2006

(54) Field emission device and field emission display device using the same

(76) Inventors: Yoon Ho Song, Daejeon (KR); Jin Ho Lee, Daejeon (KR); Kwang Yong Kang, Daejeon (KR)

Correspondence Address: LADAS & PARRY LLP, 224 SOUTH MICHIGAN AVENUE, SUITE 1600, CHICAGO, IL, 60604, US

(21) Appl. No.: 10/573,518

(22) PCT Filed: Jun. 3, 2005
(86) PCT No.: PCT/KR05/01664

§ 371 Date: Mar. 24, 2006

(30) Foreign Application Priority Data
Jun. 4, 2004 (KR) 10-2004-0041014

(51) Int. Cl. H01J 63/04

(52) U.S. Cl. 313/495

(57) ABSTRACT

Provided are a field emission device and a field emission display device using the same. The field emission device includes a cathode portion having a substrate, a cathode electrode formed on the substrate, and a field emitter connected to the cathode electrode; a field emission-suppressing gate portion formed on the cathode portion around the field emitter and surrounding the field emitter; and a field emission-inducing gate portion having a metal mesh with at least one penetrating hole, and a dielectric layer formed on at least a part of the metal mesh, wherein the field emission-suppressing gate portion suppresses electrons from being emitted from the field emitter, and the field emission-inducing gate portion induces electrons to be emitted from the field emitter. According to this configuration, the conventional problems of the field emission device including a gate leakage current, electron emission caused by an anode voltage, electron beam divergence can be significantly improved.

### BACKGROUND ART

1. Field of the Invention

The present invention relates to a field emission device and a field emission display device using the same, and more particularly, to a field emission device and a field emission display (FED) device using the same which has a field emission-suppressing gate portion performing a function of suppressing electron emission.

2. Description of Related Art

A field emission device emits electrons from a cathode emitter when an electric field is applied thereto in a vacuum or specific gas atmosphere, so that it is widely employed as an electron source of a microwave device, a sensor, a flat panel display, or the like.

Electron emission efficiency from the field emission device greatly varies according to a device structure, an emitter material, and an emitter shape. A structure of the field emission device may be mainly classified into a diode type comprised of a cathode and an anode, and a triode type comprised of a cathode, a gate, and an anode.

In the triode type field emission device, the cathode or the field emitter carries out a function of emitting electrons, the gate carries out a function of inducing the electron emission, and the anode carries out a function of receiving the emitted electrons. Since the electric field for the electron emission is applied to the gate adjacent to the emitter in the triode type structure, it allows a low voltage drive to be implemented and allows an emitting current to be readily controlled compared to the diode type, so that it is widely under development.

A field emitter material may include metal, silicon, diamond, diamond like carbon, carbon nanotube, carbon nanofiber, and the carbon nanotube and the carbon nanotube and carbon nanofiber are widely used as the emitter material because of its thin and pointed shape and stability.

Hereinafter, a structure of a spindt type field emission device among field emission devices which have been widely used in accordance with the prior art will be described. FIG. 1 is a schematic configuration view of a spindt type field emission device in accordance with the prior art.

The spindt type field emission device is comprised of a cathode, a gate, and an anode, wherein the cathode has a substrate 11, a cathode electrode 12 formed on the substrate 11, a metal tip 13, and an insulator 21 formed surrounding the metal tip 13 and having a gate opening 22 therein, and a gate electrode 23 is formed on the insulator 21. An anode electrode 32 is formed on an anode substrate 31 which is arranged to be opposite to the above-described whole structure.

In order to manufacture such a field emission device, an electron beam evaporation method is employed to form the metal tip 13 in a self-aligned manner after the gate opening 22 having a diameter of about 1 um is formed in the insulator 21 and a sacrificial isolation layer is formed thereon.

Accordingly, a fine pattern should be formed and a self-alignment technique through the electron beam evaporation method is employed during the above-described process, causing a difficulty in an application of the field emission device for implementing a large area type.

To solve such a problem during the process, efforts have been made to manufacture the field emission device using a more simplified process, thereby yielding carbon nanotube and carbon nanofiber as one of field emitter materials meeting the efforts.

Each of the carbon nanotube and the carbon nanofiber has an extremely small diameter (˜nm) and a long length (˜um) so that they are suitable for an electron emission source. However, when these materials are employed as the electron emission source to have a structure allowing electron emission to be readily induced and controlled, it is not easy to form an electron emission gate in a self-aligned manner compared to the spindt type metal tip.

FIG. 2 is a schematic configuration view of a field emission device using the carbon nanotube or the carbon nanofiber in accordance with the prior art. FIG. 2 differs from the spindt type field emission device of FIG. 1 in that the carbon nanotube or the carbon nanofiber employed as a field emitter 14 of the field emission device of FIG. 2 is exposed through a large gate opening (˜10 um) formed within an insulator.

As a result, emitted electrons often flow into the field emission gate to become a leakage current. In addition, the opening is large compared to the thickness of the insulator so that electron emission occurs due to the anode voltage, which makes it difficult to control the electron emission, and the emitted electron beams are widely diverged when the emitted electron beams reach the anode.

These phenomena degrade the characteristics of the field emission device, and in particular, may cause a severe problem when it is applied to a flat panel display.

### SUMMARY OF THE INVENTION

The present invention is directed to a new type of field emission device.

The present invention is also directed to a field emission device capable of reducing a leakage current flowing into a gate being an electron emission-inducing electrode and facilitating control of the electron emission.

The present invention is also directed to a field emission device capable of preventing a leakage current and an electron beam divergence phenomena resulted from the electron emission in a carbon nanotube or a carbon nanofiber mainly placed near a gate electrode.

One aspect of the present invention is to provide a field emission device including: a cathode portion having a substrate, a cathode electrode formed on the substrate, and a field emitter connected to the cathode electrode; a field emission-suppressing gate portion formed on the cathode portion around the field emitter and surrounding the field emitter; and a field emission-inducing gate portion having a metal mesh with at least one penetrating hole, and a dielectric layer formed on at least a part of the metal mesh, wherein the field emission-suppressing gate portion suppresses electrons from being emitted from the field emitter, and the field emission-inducing gate portion induces electrons to be emitted from the field emitter.

Another aspect of the present invention is to provide a field emission display device including: a cathode portion including cathode electrodes and field emission-suppressing gate electrodes arranged in a stripe form to allow matrix addressing to be carried out and insulated from each other on a substrate, and pixels defined by the electrodes, each pixel having a field emitter connected to the cathode electrode; a field emission-suppressing gate portion having the field emission-suppressing gate of the cathode portion and an insulator formed on a region around the field emitter in the form of surrounding the field emitter; a field emission-inducing gate portion having a metal mesh with at least one penetrating hole allowing electrons emitted from the field emitter to be penetrated, and a dielectric layer formed on at least a part of the metal mesh; and an anode portion having an anode electrode and a phosphor connected to the anode electrode, wherein the field emission-suppressing gate portion suppresses electrons from being emitted from the field emitter, and the field emission-inducing gate portion induces electrons to be emitted from the field emitter so that the electrons emitted from the field emitter collide with the phosphor via the penetrating hole.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a schematic configuration view of a spindt type field emission device in accordance with the prior art;

FIG. 2 is a schematic configuration view of a field emission device using a carbon nanotube or a carbon nanofiber in accordance with the prior art;

FIGS. 3 to 6 are schematic cross-sectional views of a field emission device in accordance with embodiments of the present invention;

FIG. 7 is a cross-sectional view illustrating a portion of a field emission display device in accordance with an exemplary embodiment of the present invention; and

FIG. 8 is a plan view for explaining a pixel array structure arranged in a matrix form in the field emission display device of FIG. 7.

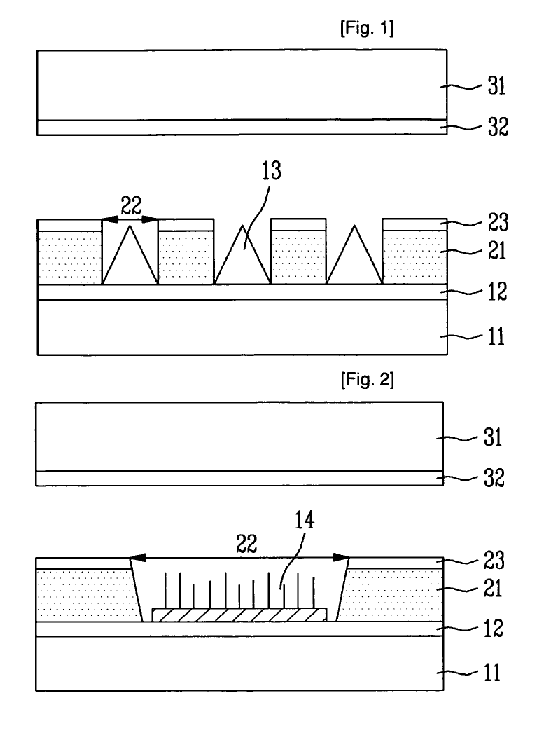

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure is thorough and complete and fully conveys the scope of the invention to those skilled in the art.

### First Embodiment

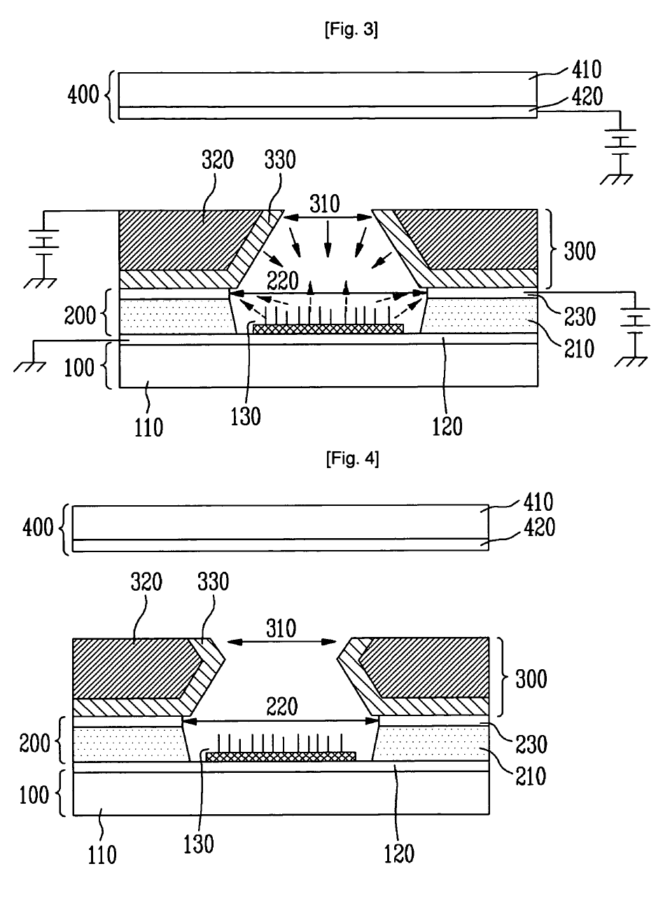

FIG. 3 is a schematic cross-sectional view of a field emission device in accordance with an embodiment of the present invention.

The field emission device of FIG. 3 includes a cathode portion 100, a field emission-suppressing gate portion 200, and a field emission-inducing gate portion 300. This field emission device, for example, may be used as one dot pixel in a field emission display, and a plurality of unit pixels are arranged in a matrix form at the time of actually manufacturing the field emission display and interconnections are included to apply various signals to each of the unit pixels. In addition, an anode portion 400 may be included to accelerate electrons emitted from the field emission device. An anode electrode 420 is formed on the anode portion 400. Alternatively, the field emission device according to the present embodiment may be variously applied to an electron beam lithography device, a microwave device and sensor, a backlight and so forth as well as the field emission display.

Alternatively, the field emission-inducing gate portion 300 may be formed on a separate substrate having a metal mesh shape.

The cathode portion 100 includes: a cathode substrate 110 formed of an insulating substrate such as glass, ceramic and polyimide; a cathode electrode 120 formed of metal, metal compound or the like on a predetermined region of the cathode substrate 110; and a film type (thin film or thick film) field emitter 130 formed of any one of diamond, diamond like carbon, carbon nanotube, carbon nanofiber or the like on a part of the cathode electrode 120. For example, the cathode substrate 110 has a thickness of 0.5 mm to 5 mm, and the cathode electrode 120 has a thickness of 0.1 um to 1.0 um.

The field emission-suppressing gate portion 200 includes: an insulator 210 formed of an oxide layer or a nitride layer; a field emission-suppressing gate opening 220 having a structure penetrating the insulator 210; and a field emission-suppressing gate electrode 230 formed of metal, metal compound or the like on a part of the insulator 210.

For example, the insulator 210 and the field emission-suppressing gate electrode 230 have a thickness of 0.5 um to 20 um, and 0.1 um to 1.0, respectively, and the field emission-suppressing gate opening 220 has a thickness of 5 um to 100 um.

The field emission-inducing gate portion 300 includes a metal mesh 320, a penetrating hole 310 formed within the metal mesh, and a dielectric layer 330 formed on at least a part of the surface opposite to the cathode portion 100. Preferably, the penetrating hole 310 has a structure that it has an inclined inner wall and a hole size thereof decreases toward the anode portion 400 from the cathode portion 100. This structure serves to focus electrons emitted from the field emitter 130 on the anode electrode 420, so that the FED having a high resolution can be manufactured. Meanwhile, it is apparent to those skilled in the art that size, shape or the like of the penetrating hole 310 are not specifically limited but can be varied.

In addition, the dielectric layer 330 formed on the inner wall of the penetrating hole 310 serves to prevent electrons emitted from the field emitter 130 from directly colliding with the metal mesh 320. Accordingly, the dielectric layer 330 may be formed on an entire surface of the metal mesh 320 or may be formed only on a part of the surface. Preferably, the dielectric layer 330 may be formed to cover the inclined inner wall of the penetrating hole 310. Meanwhile, when the dielectric layer 330 is formed only on the part of the metal mesh 320, damages due to a difference of thermal expansion coefficients may be more effectively prevented.

Various kinds including a silicon oxide layer deposited by a typical chemical vapor deposition (CVD) method, a thin film such as silicon nitride layer or the like employed for a typical semiconductor process, a silicon oxide layer formed by spin-coating a Spin-On-Glass (SOG) layer, a thick insulating layer formed by a screen printing method used for a typical plasma display panel (PDP), that is, a paste/sintering method, or the like may be employed as the dielectric layer 330, and the paste/sintering method is preferably employed to form the dielectric layer 330.

The metal mesh 320, which is separate from the cathode portion 100 and the field emission-suppressing gate portion 200, can be formed of a single metal plate such as aluminum, iron, copper, nickel or an alloy thereof, and can also be formed of an alloy plate containing a low thermal expansion coefficient such as stainless steel, invar, kovar or the like. In consideration of the function of the field emission-inducing gate portion 300, the metal mesh 320 can be formed to have a thickness of 10 [symbol] to 500 [symbol] .

Meanwhile, an electric field is applied to a direction of the field emitter 130 (a solid line direction of FIG. 3) in the metal mesh 320 so as to allow electrons to be emitted from the field emitter 130, and an electric field is applied to the field emission-suppressing gate electrode 230 in a direction (a dotted direction of FIG. 3) opposite to the electric field induced to the field emitter 130 by the metal mesh 320 so that electrons are not emitted from the field emitter 130.

The field emitter 130 may be formed of a thick film or a thin film, and may be formed such that any one of diamond, diamond like carbon, carbon nanotube and carbon nanofiber is directly grown on the cathode electrode 120 using a catalytic metal, or may be formed by printing a paste containing any one of powder type diamond, diamond like carbon, carbon nanotube and carbon nanofiber which are already grown.

Preferably, the size of the field emission-suppressing gate opening 220 of the field emission-suppressing gate portion 200 is made to be one time to twenty times larger than the thickness of the insulator 210, so that the field emission-suppressing gate electrode 230 can readily suppress electrons from being emitted from the field emitter 130. When the size exceeds the twenty times, it becomes difficult for the field emission-suppressing gate portion 200 to shield the electric field induced to the field emitter 130 due to the field emission-inducing gate portion 300, which in turn makes it difficult to suppress the field emission of the field emitter 130 caused by the field emission-inducing gate portion 300. The insulator 210 preferably has a thickness of 0.5 um to 20 um.

The field emission-inducing gate portion 300 together with the dielectric layer 330 acts to suppress electron emission from the field emitter 130 caused by the anode voltage, and can have an effect of focusing electron beams so as to allow electrons emitted from the field emitter 130 to reach a specific position of the anode portion 410.

In addition, the size of the penetrating hole 310 of the field emission-inducing gate opening 300 is made to be one time to three times larger than the sum of the thicknesses of the metal mesh 320 and the dielectric layer 330, so that the electron can be suppressed from being emitted from the field emitter 130 where the field is induced by the anode electrode 420. When the size exceeds the three times, it becomes difficult for the field emission-inducing gate portion 300 to shield the electric field induced to the field emitter 130 due to the anode voltage applied to the anode electrode 420, which in turn makes it difficult to suppress the field emission of the field emitter 130 caused by the anode voltage.

Meanwhile, the dielectric layer 330 can prevent the electrons emitted from the field emitter 130 from flowing into the field emission-inducing gate electrode 330.

In addition, an anode portion 400 may be included to accelerate the electrons emitted from the field emitter 130. The anode portion 400, for example, has an anode electrode 420 formed of a transparent conductive layer on a transparent substrate 410 such as glass, plastic, various ceramics, various transparent insulating substrates or the like. Accordingly, the anode substrate 410 having a thickness of 0.5 mm to 5.0 mm can be formed, and the anode electrode 420 having a thickness of about 0.1 um can be formed.

Meanwhile, the cathode portion 100, the field emission-suppressing gate portion 200, the field emission-inducing gate portion 300, and the anode portion 400 can be vacuum-packaged such that the field emitter 130 of the cathode portion 100 is opposed to the anode electrode 420 of the anode portion 400 via the field emission-suppressing gate opening 220 and the penetrating hole 310 of the field emission-inducing gate portion 300.

Alternatively, the cathode portion 100, the field emission-suppressing gate portion 200, the field emission-inducing gate portion 300, and the anode portion 400 may be adhered to be opposite to each other by a spacer (not shown) or the like.

In addition, an electric field is applied to the field emission-inducing gate electrode 330 in a direction toward the field emitter 130 (a solid-line arrow of FIG. 3) so as to allow electrons to be emitted from the field emitter 130, and an electric field is applied to the field emission-suppressing gate electrode 230 in a direction opposite to the direction of the electric field induced to the field emitter 130 by the field emission-inducing gate electrode (a dotted-line arrow of FIG. 3) so as not to allow electrons to be emitted from the field emitter 130. A potential of the field emission-inducing gate electrode 330 can be made to be higher than a potential of the field emitter 130, and a potential of the field emission-suppressing gate electrode 230 can be made to be lower than the potential of the field emitter 130.

For example, as shown in FIG. 3, the field emitter 130 is grounded, a positive voltage is applied to the field emission-inducing gate electrode 330 and a negative voltage is applied to the field emission-suppressing gate electrode 230.

Meanwhile, the field emission-inducing gate portion 300 can be manufactured in a mesh form which is independent from the cathode portion 100 and the field emission-suppressing gate portion 220 so that its manufacturing process is very simple and its manufacturing productivity and yield can be enhanced.

FIG. 4 is a cross-sectional view of a field emission device in accordance with another embodiment of the present invention. A part different from the above-described embodiment will be described for simplicity of description.

This embodiment of FIG. 4 differs from the FED of FIG. 3 in a shape of the metal mesh 320 of the field emission-inducing gate portion 300. According to the present embodiment, an inner wall of the metal mesh 320 does not have a single inclined angle but have at least two inclined angles. Preferably, the inner wall of the metal mesh 320 may be formed to have a protrusion. By means of this structure, electrons emitted from the field emitter 130 can be more effectively focused on the anode electrode 420 of the anode portion 400 facing the field emitter.

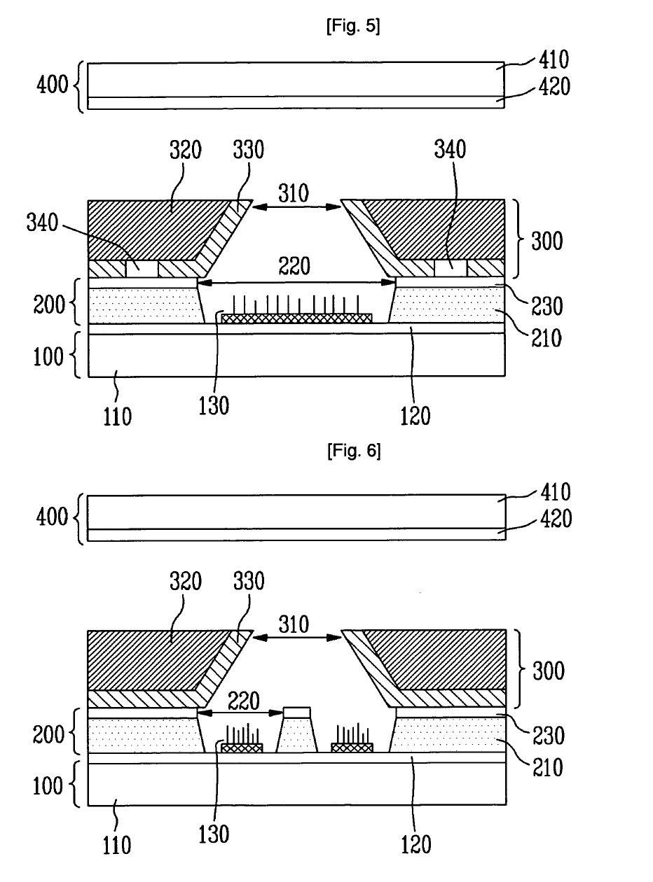

FIG. 5 is a cross-sectional view of a field emission device in accordance with yet another embodiment of the present invention. A part different from the above-described embodiment will be described for simplicity of description.

This embodiment differs from the FED of FIG. 3 in that the dielectric layer 330 of the field emission-inducing gate portion 300 is formed only on a part of the metal mesh 320 in the field emission device of FIG. 5. A region where the dielectric layer 330 is not formed (denoted by reference numeral 340 in FIG. 5) may be left empty. Such a structure can prevent the dielectric layer 330 from being damaged due to a difference of thermal expansion coefficients between the metal mesh 320 and the dielectric layer 330. That is, it is more effective to prevent damages due to the difference of thermal expansion coefficients when the dielectric layer 300 is formed only on a part of the metal mesh 320.

FIG. 6 is a schematic cross-sectional view of a field emission device in accordance with still another embodiment of the present invention. A part different from the above-described embodiment will be described for simplicity of description. FIG. 6 is a cross-sectional view of a unit pixel taken along a part of the field emission device in accordance with another embodiment of the present invention.

This embodiment differs from the field emission device of FIG. 3 in that a plurality of openings 220 of the field emission-suppressing gate portion 200 is formed per unit pixel. In this case, the dot number of the field emitter 130 of the cathode portion 100 may be equal to the number of the openings 220, and the number of the field emitter 130 may also be one. Referring to FIG. 6, the dot number of the field emitter 130 of the cathode portion 100 is shown to be equal to the number of the openings 220. The number of the penetrating hole 310 of the field emission-inducing gate portion 300 is one per unit pixel. However, the number of the penetrating hole 310 may be varied per unit pixel in a modified embodiment.

Such a structure has an advantage allowing a high voltage to be effectively applied to the anode electrode 420, which can prevent an electric field by the high voltage of the anode electrode from adversely affecting the field emitter 130 via several dots.

Field Emission Display Device

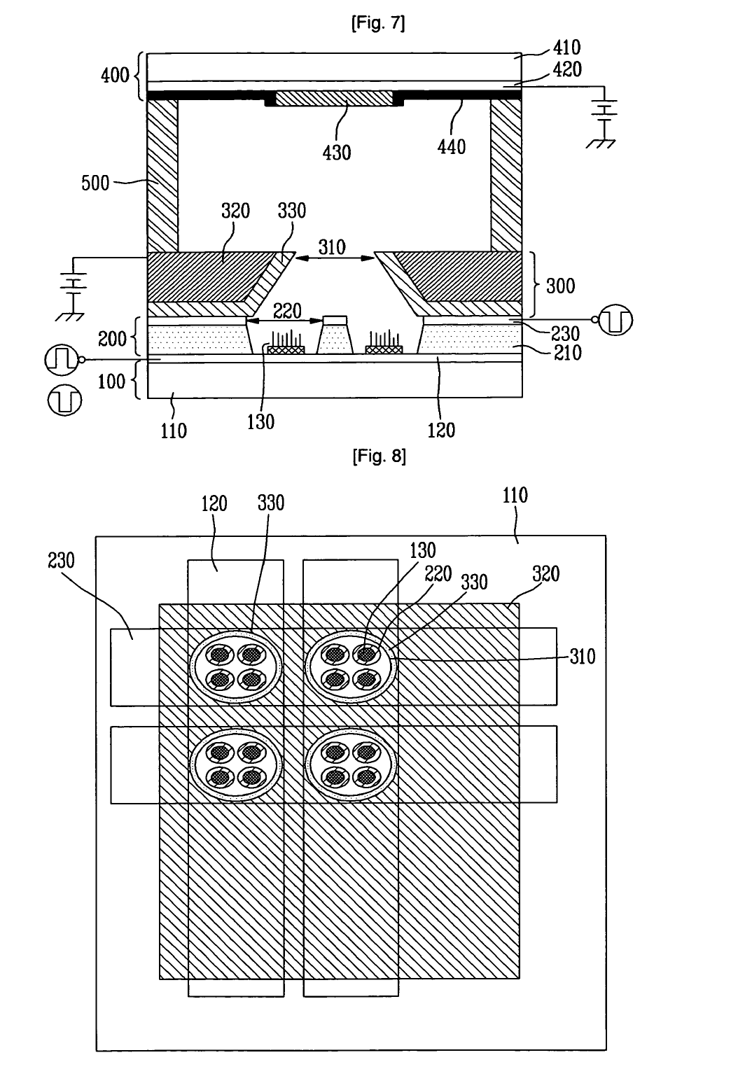

Next, an example of manufacturing a field emission display device using a field emission device according to an exemplary embodiment of the present invention will be described with reference to FIGS. 7 and 8.

FIG. 7 is a cross-sectional view illustrating a portion of a field emission display device in accordance with an exemplary embodiment of the present invention, and FIG. 8 is a plan view for explaining a pixel array structure arranged in a matrix form in the field emission display device of FIG. 7.

Referring to FIG. 7, the field emission display device is comprised of a cathode portion 100, a field emission-suppressing gate portion 200, a field emission-inducing gate portion 300, and an anode portion 400.

The cathode portion 100 includes cathode electrodes 120 and field emission-suppressing gate electrodes 230 arranged in a stripe form allowing matrix addressing to be carried out and being insulated from each other on a substrate 110, and pixels defined by the electrodes wherein each pixel has a field emitter 130 connected to the cathode electrode 120. The field emission-suppressing gate portion 200 has an insulating layer 210 formed on a region around the field emitter, the field emission-suppressing gate electrode 230, and an opening 210. The field emission-inducing gate portion 300 includes a metal mesh 320 and a penetrating hole 310 formed within the metal mesh 320, and a dielectric layer 330 formed on at least a part of the metal mesh facing the cathode portion 100.

A detailed description of the cathode portion 100, the field emission-suppressing gate portion 200, and the field emission-inducing gate portion 300 is the same as the above-described field emission device so that its description will be omitted for simplicity.

The anode portion 400 has anode electrodes 420, phosphors 430 of red (R), green (G) and blue (B) colors formed on a part of each of the anode electrodes 420, and a black matrix 440 formed between the phosphors 430, on an anode substrate 410 formed of a transparent insulating substrate such as glass. The cathode portion 100, the field emission-suppressing gate portion 200, the field emission-inducing gate portion 300, and the anode portion 400 are vacuum-packaged such that the field emitter 130 of the cathode portion 100 is aligned opposite to the phosphor 430 of the anode portion 400 via the penetrating hole 310 of the field emission-inducing gate portion 300 and the opening 220 of the field emission-suppressing gate portion 200 using a spacer 500 as a support therebetween. In this case, the spacer 500 serves to keep an interval between the anode portion 400, and the cathode portion 100, the field emission-suppressing gate portion 200 and the field emission-inducing gate portion 300, and the spacer 500 does not need to be necessarily disposed to all pixels.

Hereinafter, an example of a driving method for the present field emission device will be described in detail.

A constant direct current voltage, for example, 100V to 1500V is applied to the metal mesh 330 of the field emission-inducing gate portion 300 to induce the electron emission from the field emitter 130 of the cathode portion 100 while a high direct current voltage (e.g. 1000V to 15000V) is applied to the anode electrode 420 of the anode portion 400 to accelerate the emitted electrons with a high energy, and a display scan pulse signal having a negative voltage of about 0V to 50V is applied to the field emission-suppressing gate electrode 230 and a data pulse signal having a negative voltage of 0V to 50V or a positive voltage of 0V to 50V is applied to the cathode electrode 120, thereby realizing images.

In this case, gray representation of the display can be obtained by modulating a pulse amplitude or a pulse width of the data signal applied to the cathode electrode 120.

Referring to FIG. 8, respective dot pixels of FIG. 7 are arranged in a matrix shape, and the cathode electrode 120 and the field emission-suppressing gate electrode 230 are arranged as matrix addressing electrodes of the field emission display. The anode portion 400 is not shown and the size of the field emitter 130 is smaller than the field emission-inducing gate penetrating hole 310 in FIG.8, however, it is apparent to those skilled in the art that the size of the field emitter 130 can be formed to be larger than the penetrating hole 310 of the field emission-inducing gate portion 300 at the time of actual implementation.

According to the present invention as mentioned above, when the field emission device of the present invention is applied to the field emission display device, the electric field necessary for the field emission is applied via the metal mesh of the field emission-inducing gate portion, so that an interval between the anode portion and the cathode portion can be freely adjusted, thereby significantly enhancing the brightness of the field emission display.

The field emission device of the present invention can significantly improve problems including a gate leakage current, electron emission caused by an anode voltage, electron beam divergence of the conventional carbon field emission device.

In addition, a voltage applied to the field emission-inducing gate electrode suppresses electron emission of the field emitter caused by the anode voltage, and a uniform potential is formed as a whole between the anode portion and the gate portion to prevent local arcing, thereby significantly enhancing a lifetime of the field emission display.

Meanwhile, the penetrating hole having an inclined inner wall of the field emission-inducing gate portion acts to focus electrons emitted from the field emitter on the phosphor of the anode facing the emitter, thereby allowing a field emission display device having a high resolution to be manufactured.

Although exemplary embodiments of the present invention have been described with reference to the attached drawings, the present invention is not limited to these embodiments, and it should be appreciated to those skilled in the art that a variety of modifications and changes can be made without departing from the spirit and scope of the present invention.

1. A field emission device comprising:
a cathode portion having a substrate, a cathode electrode formed on the substrate, and a field emitter connected to the cathode electrode;
a field emission-suppressing gate portion formed on the cathode portion around the field emitter and surrounding the field emitter; and
a field emission-inducing gate portion having a metal mesh with at least one penetrating hole, and a dielectric layer formed on at least a part of the metal mesh,
wherein the field emission-suppressing gate portion suppresses electrons from being emitted from the field emitter, and the field emission-inducing gate portion induces electrons to be emitted from the field emitter.

2. The field emission device according to claim 1, wherein the dielectric layer of the field emission-inducing gate portion is formed on an entire surface or a portion of the surface of the metal mesh.

3. The field emission device according to claim 1, wherein a size of the penetrating hole of the field emission-inducing gate portion is not greater than one time to three times a thickness sum of the metal mesh and the dielectric layer.

4. The field emission device according to claim 1, wherein the penetrating hole of the metal mesh has at least one inclined inner wall.

5. The field emission device according to claim 4, wherein the dielectric layer covers the inclined inner wall of the penetrating hole.

6. The field emission device according to claim 1, wherein the field emission-suppressing gate portion is electrically insulated from the field emission-inducing gate portion, and has an insulator with a field emission-suppressing gate opening therein, and a field emission-inducing gate electrode formed on the insulator.

7. The field emission device according to claim 6, wherein a size of the field emission-suppressing gate opening is one time to twenty times a thickness of the insulator.

8. The field emission device according to claim 4, wherein the inner wall of the metal mesh includes a protrusion having at least two inclined angles.

9. The field emission device according to claim 1, wherein the metal mesh of the field emission-inducing gate portion is a metal plate formed of one of aluminum, iron, copper and nickel, or an alloy plate containing at least one of stainless steel, invar and kovar.

10. The field emission device according to claim 1, wherein the field emission-suppressing gate portion is divided into plural ones per unit pixel.

11. The field emission device according to claim 1, wherein a size of the penetrating hole of the metal mesh in the cathode portion is larger than that in the anode portion.

12. The field emission device according to claim 1, wherein the field emitter is formed of a thin or thick film formed of one of diamond, diamond like carbon, carbon nanotube, and carbon nanofiber.

13. The field emission device according to claim 12, wherein the field emitter is formed by directly growing any one of diamond, diamond like carbon, carbon nanotube, and carbon nanofiber on the cathode electrode using a catalytic metal.

14. The field emission device according to claim 12, wherein the field emitter is formed by printing a paste containing any one of powder type diamond, diamond like carbon, carbon nanotube and carbon nanofiber.

15. A field emission display device comprising:
a cathode portion including cathode electrodes and field emission-suppressing gate electrodes arranged in a stripe form to allow matrix addressing to be carried out and insulated from each other on a substrate, and pixels defined by the electrodes, each pixel having a field emitter connected to the cathode electrode;
a field emission-suppressing gate portion having an insulator with a gate opening in the field emission-suppressing gate of the cathode portion formed on a region around the field emitter in the form of surrounding the field emitter;
a field emission-inducing gate portion having a metal mesh with at least one penetrating hole allowing electrons emitted from the field emitter to pass therethrough, and a dielectric layer formed on at least a part of the metal mesh;
and
an anode portion having an anode electrode and a phosphor connected to the anode electrode,
wherein the field emission-suppressing gate portion suppresses electrons from being emitted from the field emitter, and the field emission-inducing gate portion induces electrons to be emitted from the field emitter so that the electrons emitted from the field emitter collide with the phosphor via the penetrating hole.

16. The field emission display device according to claim 15, wherein the cathode portion, the field emission-suppressing gate portion, the field emission-inducing gate portion, and the anode portion are vacuum-packaged such that the field emitter of the cathode portion is opposed to the anode electrode of the anode portion via a field emission-suppressing gate opening and the penetrating hole.

17. The field emission display device according to claim 16, wherein a constant direct current voltage is applied to the field emission-inducing gate portion to induce electron emission from the field emitter of the cathode portion, and a scan signal having a negative voltage is input to the field emission-suppressing gate portion and a data signal having a positive or negative voltage is input to the cathode portion to display an image.

18. The field emission display device according to claim 17, wherein a pulse amplitude or a pulse width of the data signal is modulated to represent a gray scale.

19. The field emission display device according to claim 15, wherein the anode portion is composed of a transparent substrate, transparent electrodes formed on the transparent substrate, phosphors of red (R), green (G) and blue (B) colors formed on a predetermined region of each transparent electrode, and a black matrix formed between the phosphors.

20. The field emission display device according to claim 15, wherein the field emission-inducing gate portion is formed on a separate substrate.

21. The field emission display device according to claim 15, wherein the cathode portion, the field emission-suppressing gate portion, and the field emission-inducing gate portion are opposed to the anode portion using a spacer as a support.

22. The field emission display device according to claim 15, wherein the dielectric layer is formed on an entire surface or a part of the surface of the metal mesh.

23. The field emission display device according to claim 15, wherein a size of the field emission-suppressing gate opening is equal to or smaller than one time to twenty times a thickness of the insulator layer.

24. The field emission display device according to claim 15, wherein the penetrating hole of the metal mesh has at least one inclined inner wall.
